(19) United States
(12) Patent Application Publication
(10) Pub. No.: US 2024/0195091 A1
(43) Pub. Date: Jun. 13, 2024

(54) Connector and Device Comprising the Same

(71) Applicants: TE Connectivity India Private Limited, Bangalore (IN); Tyco Electronics (Shanghai) Co., Ltd., Shanghai (CN); TE Connectivity Italia Distribution S.r.l., Torino (IT)

(72) Inventors: Yongjia (Winter) Wang, Shanghai (CN); Subhash Maheshbabu, Bangalore (IN); Federico Lupo, Torino (IT)

(73) Assignees: TE Connectivity India Private Limited, Bangalore (IN); Tyco Electronics (Shanghai) Co., Ltd., Shanghai (CN); TE Connectivity Italia Distribution S.r.l., Torino (IT)

(21) Appl. No.: 18/537,025

(22) Filed: Dec. 12, 2023

(30) Foreign Application Priority Data
Dec. 13, 2022 (CN) 2022 2 3342687.6

(51) Int. Cl. H01R 12/51; H01R 12/57

(52) U.S. Cl. CPC H01R 12/515; H01R 12/57

(57) ABSTRACT

A connector includes a housing and a plurality of terminals. The housing defines a plurality of receiving channels, and a stopper formed in each of the receiving channels. The plurality of terminals are arranged in respective ones of the plurality of receiving channels. Each terminal includes a first end adapted to be connected to a wire, and a second end adapted to be connected to a mating terminal. Each stopper opposes the second end of a respective one of plurality of terminals and is adapted to prevent the second end of the terminal from disengaging from the mating terminal when the wire is subjected to an external force.

### CROSS-REFERENCE TO RELATED APPLICATION

This application claims the priority of Chinese Patent Application No. CN 202223342687.6 filed on Dec. 13, 2022, the whole disclosure of which is incorporated herein by reference.

### FIELD OF THE INVENTION

The present disclosure relates to a connector and a device comprising the same.

### BACKGROUND

A connector is a device used to connect two active devices to transmit current or signals. A connector may simplify the assembly process of electronic products, the mass production process of electronic products, as well as their repair and/or replacement. With the advancement of technology, electronic products equipped with connectors may update electronic elements, replacing old electronic elements with new and better performing ones. A connector may enhance the flexibility of product design when designing and integrating new products, as well as when composing a system with electronic elements. Therefore, connectors are widely used in fields such as transportation, healthcare, aerospace, military, and home appliances.

The basic performance of a connector may be divided into three categories: mechanical performance, electrical performance, and environmental performance. Plugging force and mechanical life are significant mechanical performance parameters. The plugging force and mechanical life of a connector are related to a structure (positive pressure) of an element contacting with the connector, a coating quality (sliding friction coefficient) of a contact area, and a size accuracy of a contact arrangement (alignment). Main electrical performance parameters of a connector include a contact resistance, an insulation resistance, and a dielectric strength. Among them, a desired electrical connector should have a low and stable contact resistance, which ranges from a few milliohms to tens of milliohms. An insulation resistance is an index that indicates an insulation performance between contacts of an electrical connector and between the contacts and a housing of the electrical connector. An order of magnitude of the insulation resistance ranges from hundreds of megaohms to thousands of megaohms. Dielectric strength is an ability of the electrical connector to withstand a rated test voltage between the contacts of the electrical connector or between the contacts and the housing of the electrical connector. Environmental performance parameters includes temperature resistance, humidity resistance, salt spray resistance, vibration, and impact resistance, etc.

The development of connector technology shows the following trends and design requirements: high speed and digitization of signal transmission, integration of various types of signal transmission, miniaturization of product volume, low cost of products, modular combination, convenience of plugging and the like. However, in the application environments of existing devices, the device usually vibrates due to handling or harsh conditions, causing terminals of the connector in the device to poorly contact with other components and thus electrically disconnect from them. This not only brings significant challenges to the reliability of the device, but also requires significant time and manpower to troubleshoot and maintain the device.

### SUMMARY

According to an embodiment of the present disclosure, a connector includes a housing and a plurality of terminals. The housing defines a plurality of receiving channels, and a stopper formed in each of the receiving channels. The plurality of terminals are arranged in respective ones of the plurality of receiving channels. Each terminal includes a first end adapted to be connected to a wire, and a second end adapted to be connected to a mating terminal. Each stopper opposes the second end of a respective one of plurality of terminals and is adapted to prevent the second end of the terminal from disengaging from the mating terminal when the wire is subjected to an external force.

### BRIEF DESCRIPTION OF THE DRAWINGS

The invention will now be described by way of example with reference to the accompanying Figures, of which:

FIG. 1 is a perspective view of a connector forming an electrical connection between a wire and a PCB board according to an embodiment of the present disclosure;

FIG. 2 is an exploded view of the connector, the wire and the PCB board shown in FIG. 1;

FIG. 3 is a perspective view showing a separate housing of the connector illustrated in FIG. 2;

FIG. 4 is a cross-sectional view taken along line IV-IV in FIG. 1; and

FIG. 5 is a cross-sectional view of the connector illustrated in FIG. 4 when the wire in the connector is subjected to an external force.

### DETAILED DESCRIPTION OF THE EMBODIMENTS

In order to make the purposes, technical schemes, and advantages of the present disclosure clearer, the present disclosure is further described in detail in combination with specific embodiments and with reference to the accompanying drawings.

However, it should be understood that these descriptions are only illustrative and are not intended to limit the scope of the present disclosure. In the following detailed description, for the sake of explanation, many specific details are set forth to provide a comprehensive understanding of the embodiments of the present disclosure. However, it is obvious that one or more embodiments may also be implemented without these specific details. In addition, in the following description, the description of the well-known technology is omitted to avoid unnecessary confusion of the concepts of the present disclosure.

The terms used herein are only for the purposes of describing specific embodiments and are not intended to limit the present disclosure. The term “comprise” and “include” as used herein indicate the existence of features, steps, and operations, but do not exclude the existence or addition of one or more other features.

In the case of using the expression like “at least one of A, B, and C, etc.”, it should be generally explained according to the meaning of the expression generally understood by those skilled in the art (for example, “a system having at least one of A, B and C” should comprise but is not limited to systems having only A; having only B; having only C, having A and B; having A and C; having B and C, and/or having A, B and C; etc.). In the case of using the expression like “at least one of A, B, or C, etc.”, it should be generally explained according to the meaning of the expression generally understood by those skilled in the art (for example, “a system having at least one of A, B or C” should comprise but is not limited to systems having only A; having only B; having only C; having A and B; having A and C; having B and C; and/or having A, B and C; etc.)

All terms used herein (comprising technical and scientific terms) have the meanings generally understood by those skilled in the art, unless otherwise defined. It should be noted that the terms used herein should be interpreted as having the meaning consistent with the context of this specification and should not be interpreted in an idealized or overly rigid manner.

Referring to FIGS. 1-5, a connector 1000 is disclosed which forms an electrical connection between wires 300 and a PCB board 400. The connector 1000 comprises a housing 100 and a plurality of terminals 200. At least one receiving channel 110 is provided in the housing 100. In this embodiment, for the sake of description, three receiving channels 110 are described as an example.

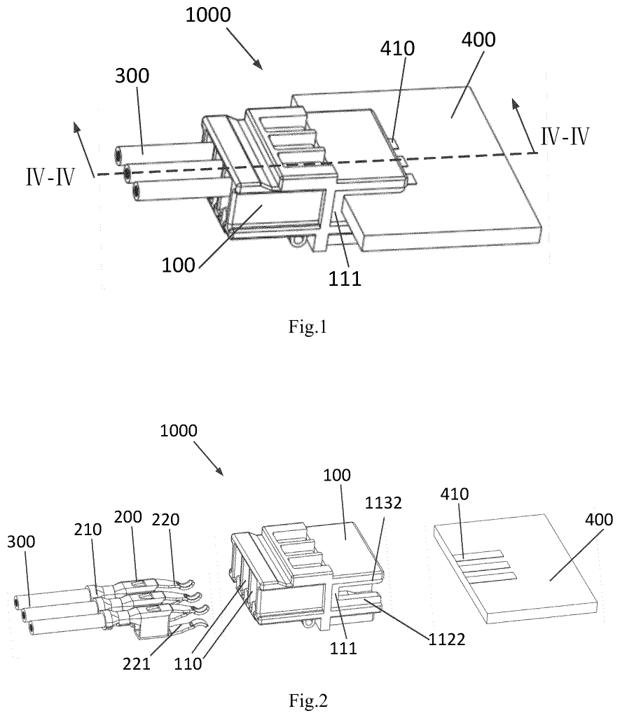

Each of the terminals 200 is accommodated in corresponding one of the three receiving channels 110, i.e., the terminals 200 are respectively accommodated in the three receiving channels 110 in a one-to-one corresponding manner. A first end 210 of each of the terminals 200 is connected to one of the wires 300, and a second end 220 of each of the terminals 200 is connected to matching terminals 410 respectively located on two opposite sides of the PCB board 400 (for the sake of clarity, only three matching terminals 410 located on one side of the PCB board 400 are shown in FIG. 2). The first end 210 of each of the terminals 200 defines a cylinder shape so as to accommodate and fix one of the wires 300. The second end 220 of each of the terminals 200 is defines two elastic arms 221 extending obliquely towards each other, which abut respectively against the two opposite sides of the PCB board 400 to contact with corresponding ones of the matching terminals 410.

Each of the receiving channels 110 is provided with stoppers 1121, 1131 therein. The stoppers 1121, 1131 comprise a first stopper 1121 and a second stopper 1131. The first stopper 1121 is provided on a bottom wall 112 of the receiving channel 110. The second stopper 1131 is provided on a top wall 113 of the receiving channel 110. The first stopper 1121 is aligned with one of the elastic arms 221, and the second stopper 1131 is aligned with the other of the elastic arms 221.

The stoppers 1121, 1131 are adapted to prevent the second end 220 of each of the terminals 200 from disengaging from corresponding one of the matching terminals 410 when the wire 300 accommodated into the terminal 200 is subjected to an external force F (see FIG. 5). In this way, the stoppers 1121, 1131 ensure and maintain the electrical connection between each of the terminals 200 and corresponding one of the matching terminals 410. This not only improves reliability of a device associated with the connector 1000, but also avoids costly and time-consuming troubleshooting and maintenance of the connector 1000.

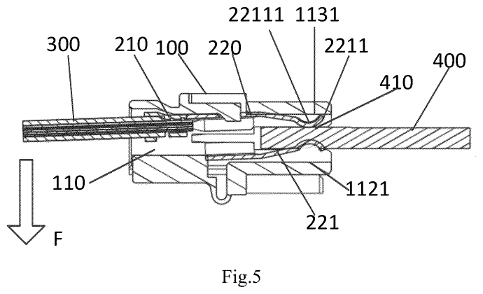

Each of the receiving channels 110 is further provided with two opposite first side walls 1122 and two opposite second side walls 1132. The two opposite first side walls 1122 are positioned on opposite sides of the first stopper 1121 on the bottom wall 112 respectively, and the two opposite second side walls 1132 are positioned on opposite sides of the second stopper 1131 on the top wall 113, respectively. Each of the first side walls 1122 protrudes from the bottom wall 112 towards corresponding one of the second side walls 1132 beyond the first stopper 1121, and each of the second side walls 1132 protrudes from the top wall 113 towards corresponding one of the first side walls 1122 beyond the second stopper 1131. Each of the first side walls 1122 and corresponding one of the second side walls 1132 are aligned with and spaced apart from each other, so that the PCB board 400 is inserted between the first side walls 1122 and the second side walls 1132 and is secured between the first side walls 1122 and the second side walls 1132 by an interference fit. Each of the two clastic arms 221 of the terminal 200 comprises an arc-shaped free end 2211, which is configured to abut against corresponding one of the matching terminals 410 after the PCB board 400 is inserted between the first side walls 1122 and the second side walls 1132, referring to FIGS. 4 to 5.

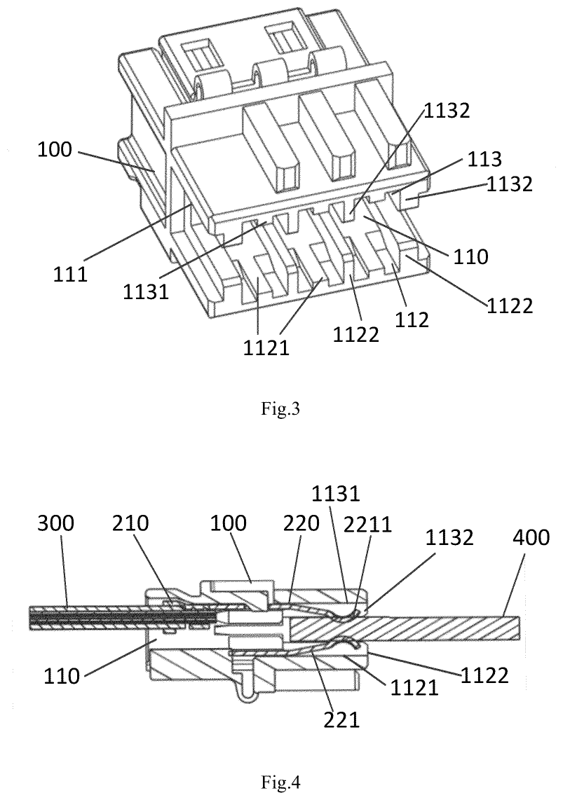

Referring particularly to FIG. 3, each of the first stopper 1121 and the second stopper 1131 is formed as a strip extending longitudinally along the receiving channel 110. In this way, a tip of each of the free ends 2211 abuts against the strip to maintain an arc-shaped portion 22111 of each of the free ends 2211 in contact with corresponding one of the matching terminals 410 when the wire 300 is subjected to the external force F. However, those skilled in the art should understand that the shapes of the stoppers 1121, 1131 are not limited to the strips, as long as the shapes of the stoppers 1121, 1131 are suitable to keep the arc-shaped portion 22111 of each of the free ends 2211 in contact with corresponding one of the matching terminals 410 when the wire 300 is subjected to the external force F.

Each of the receiving channels 110 is further provided with a limiter 111 (see FIG. 2). The limiter 111 is connected between one of the first side walls 1122 and corresponding one of the second side walls 1132, both of which are aligned with and spaced apart from each other, so as to form a “C” shape together with them. In this way, a distance at which the PCB board 400 is inserted into the housing 100 is limited by a front end of the PCB board 400 abutting against the limiter 111. Thus, the arc-shaped portion 22111 of each of the free ends 2211 may contact corresponding ones of the matching terminals 410.

The embodiments of the present disclosure have been described in detail in combination with the drawings. It should be noted that the implementation methods not illustrated or described in the drawings, or the description are in a form known to those skilled in the art and are not described in detail. In addition, the above definitions of individual parts are not limited to various specific structures, shapes or modes mentioned in the embodiments, which can be simply changed or replaced by those skilled in the art.

It should also be noted that in the specific embodiments of the present disclosure, unless explicitly specified, the numerical parameters in the specification and the appended claims are approximate values and can be changed according to the required characteristics obtained through the content of the present disclosure. Specifically, all numbers used in the description and claims to indicate the sizes, scope conditions, etc. of the components should be understood as being modified by the term “about” in all cases. In general, the meaning of its expression is to comprise a variance of +10% in some embodiments, a variance of +5% in some other embodiments, a variance of +1% in still some other embodiments, and a variance of +0.5% in the other embodiments.

What is claimed is:

1. A connector comprising:
a housing defining:
a receiving channel; and
a stopper formed in the receiving channel; and
a terminal arranged in the receiving channel and having a first end connected to a wire, and a second end connected to a mating terminal, the stopper preventing the second end of the terminal from disengaging from the mating terminal when the wire is subjected to an external force.

2. The connector according to claim 1, wherein the stopper includes a first stopper defined on a bottom wall of the receiving channel.

3. The connector according to claim 2, wherein the stopper further includes a second stopper defined on a top wall of the receiving channel.

4. The connector according to claim 3, wherein the first end of the terminal defines a cylindrical shape accommodating the wire.

5. The connector according to claim 4, wherein:
the second end of the terminal includes first and second elastic arms extending obliquely towards each other;
the first stopper is aligned with the first elastic arm; and
the second stopper is aligned with the second elastic arm.

6. The connector according to claim 5, wherein the receiving channel further includes:
two first side walls arranged on opposite sides of the first stopper on the bottom wall; and
two second side walls arranged on opposite sides of the second stopper on the top wall.

7. The connector according to claim 6, wherein each of the first side walls and corresponding ones of the second side walls are aligned with and spaced apart from each other.

8. The connector according to claim 7, wherein each of the first side walls protrudes from the bottom wall towards a corresponding one of the second side walls beyond the first stopper, and each of the second side walls protrudes from the top wall towards a corresponding one of the first side walls beyond the second stopper.

9. The connector according to claim 8, wherein the mating terminal is defined on a printed circuit board inserted between the first side walls and the second side walls.

10. The connector according to claim 9, wherein each of the first and second elastic arms comprises an arc-shaped free end abutting against the mating terminal after the printed circuit board is inserted between the first side walls and the second side walls.

11. The connector according to claim 10, wherein each of the first and second stoppers is formed as a strip extending longitudinally along the receiving channel, a tip of each of the free ends abuts against the strip to maintain contact between the free ends and the mating terminal when the wire is subjected to the external force.

12. The connector according to claim 7, wherein the receiving channel further defines a limiter connected between one of the first side walls and corresponding one of the second side walls, the limiter limiting a distance which a printed circuit board is inserted into the housing.

13. The connector according to claim 12, wherein corresponding the limiter and the corresponding first and second side walls define a C-shape.

14. A connector, comprising:
a housing defining a plurality of receiving channels, and a stopper formed in each of the receiving channels; and
a plurality of terminals arranged in respective ones of the plurality of receiving channels, each terminal having a first end adapted to be connected to a wire, and a second end adapted to be connected to a mating terminal, each stopper opposing the second end of a respective one of plurality of terminals and adapted to prevent the second end of the terminal from disengaging from the mating terminal when the wire is subjected to an external force.

15. The connector according to claim 14, wherein the second end of the terminal includes first and second elastic arms extending obliquely towards each other, the first stopper is aligned with the first elastic arm, and the second stopper is aligned with the second elastic arm.

16. The connector according to claim 15, wherein the stopper includes:
a first stopper defined on a bottom wall of the receiving channel; and
a second stopper defined on a top wall of the receiving channel.

17. The connector according to claim 16, wherein each of the receiving channels further includes:
two first side walls arranged on opposite sides of the first stopper on the bottom wall; and
two second side walls arranged on opposite sides of the second stopper on the top wall.

18. The connector according to claim 17, wherein each of the first side walls and corresponding ones of the second side walls are aligned with and spaced apart from each other, the corresponding first side walls and the second side walls defining an opening adapted to receive a printed circuit board defining the mating terminal.

19. The connector according to claim 17, wherein each of the first side walls protrudes from the bottom wall towards a corresponding one of the second side walls beyond the first stopper, and each of the second side walls protrudes from the top wall towards a corresponding one of the first side walls beyond the second stopper.

20. The connector according to claim 16, wherein each of the first and second stoppers is formed as a strip extending longitudinally along the receiving channel, a tip of each of the first and second elastic arms of the terminal abuts against the strip to maintain the elastic arms in contact with the mating terminal when the wire is subjected to the external force.
